(19) United States
(12) Patent Application Publication
(10) Pub. No.: US 2008/0248346 A1
(43) Pub. Date: Oct. 9, 2008

(54) START UP METHOD FOR FUEL CELL AND FUEL CELL POWER GENERATION SYSTEM

(75) Inventors: Hidekazu Fujimura, Mito (JP); Tsutomu Okusawa, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/060,892

(22) Filed: Apr. 2, 2008

(30) Foreign Application Priority Data
Apr. 3, 2007 (JP) 2007-097314

(51) Int. Cl. H01M 8/02

(52) U.S. Cl. 429/17; 429/34

(57) ABSTRACT

A methanol water solution circulation system having a smaller heat capacity than that of a methanol water solution circulation system used at time of regular operation or a methanol water solution circulation system having a small total volume is installed for startup. Startup fuel is supplied to an anode, and the temperature thereof is raised using heat generation action of the fuel cell, thus the temperature of the cell rises. Fuel at the exit of the anode is circulated again to the entrance of the anode, and the processing is repeated, thus the power generation cell is heated up to the operating temperature.

### CLAIM OF PRIORITY

The present application claims priority from Japanese application serial No. 2007-097314, filed on Apr. 3, 2007, the content of which is hereby incorporated by reference into this application.

### FIELD OF THE INVENTION

The present invention relates to a start up method for a fuel cell and a fuel cell power generation system for the executing the method. The present invention is particularly applicable suitably to a direct methanol fuel cell.

### BACKGROUND OF THE INVENTION

The fuel cell is a cell that generally, an anode, an electrolytic layer, and a cathode are laminated to structure a fuel cell, and the anode is supplied with fuel such as hydrogen as a reducing agent, and the cathode is supplied with oxygen (for example, atmospheric oxygen) as an oxidizing agent, and fuel supply and discharge of reaction products are executed continuously, and an electrochemical reaction is caused by fuel and oxygen, thus power is obtained and various types of fuel cells are developed.

A solid polymeric fuel cell which is a kind of a fuel cell, compared with other kinds of fuel cells, has a characteristic of a low operating temperature and a high output density, can reduce the cost, and can realize easily compactness and reduction in weight, so that it can be developed to application to a drive power source and a charger of electric equipment. Particularly, a direct methanol fuel cell (DMFC) capable of generating power only by supplying liquid fuel including methanol and water directly to the anode has been noticed recently.

In the DMFC, a methanol water solution is supplied to the anode as fuel, and air is supplied generally to the cathode, and an electrochemical reaction is caused in each cell, thus power is generated, and reaction products generated by the electrochemical reaction are discharged. At this time, carbon dioxide is discharged from the anode and water is discharged from the cathode as a product.

Although the operating temperature of the DMFC depends on the characteristics of the electrolytic film, it is almost 50° C. to 80° C., so that when start up the fuel cell from its stop status, the fuel cell must rise up to its operating temperature and particularly, in a low temperature environment, a problem arises that the fuel cell cannot be started instantaneously.

To solve this problem, there is a method available for driving by using an auxiliary battery such as a secondary cell represented by a lithium ion cell until the fuel cell can be started. However, if it takes a lot of time until start, a battery having a large electric capacity in correspondence to it is necessary. Further, there is a heating method available using a heater or catalyst combustion, though it requires a battery power source and a combustion catalyst, causing complication of the system and an increase in cost.

At the start time of the fuel cell, a method for supplying fuel in higher concentration than that at the time of regular operation, promoting the heat generation reaction, thereby raising the cell temperature is known (for example, refer to Japanese Patent Laid-open No. 2006-4868).

### SUMMARY OF THE INVENTION

However, in the fuel cell system described in the Japanese Patent Laid-open No. 2006-4868, for high concentration, differently from at the regular time, a tank having a fuel concentration adjustment mechanism is necessary. Furthermore, for the purpose of promotion of the heat generation reaction due to the methanol oxidation reaction instead of the electrochemical reaction, high-concentration fuel is used at the time of start, so that the use amount of fuel used for other than power generation is increased, thus from the viewpoint of fuel efficiency and power generation efficiency, it cannot be said that it is preferable. Further, sudden heat generation is never preferable to the electrolytic film and electrode and there are possibilities of expediting deterioration.

An object of the present invention is to provide a start up method for a fuel cell for minimizing the fuel consumption even at a low environmental temperature, start up in a short period of time, and moreover, suppressing inasmuch as is possible sudden heat generation due to the methanol oxidation reaction other than the electrochemical reaction at the start time and a fuel cell power generation system for executing the method.

The start up method for the fuel cell power generation system of the present invention is a method for increasing the temperature of liquid fuel used in the fuel cell using the heat generation action of the fuel cell, thereby increasing the temperature of the cell, which, at the start time, supplies fuel having a lower heat capacity than that at the time of regular operation to the anode of the power generation cell and circulates again the fuel at the exit of the anode into the entrance of the anode.

Further, the fuel cell power generation system for realizing the aforementioned start up method, separately from the fuel supply circulation system at the time of regular operation, has a fuel supply circulation system exclusively used at the start time and the volume of the fuel solution in the pipe of the startup fuel supply circulation system is made smaller than the volume of the fuel solution in the pipe of the fuel supply circulation system at the time of regulation operation. Or, the heat capacity of the pipe of the startup fuel supply circulation system is made smaller than the heat capacity of the pipe of the fuel supply circulation system at the time of regular operation.

Furthermore, the system includes a means for supplying a fuel solution to the startup fuel supply circulation system and a fuel storing container for storing the supplied fuel solution and the volume of the fuel storing container is made smaller than the volume of the fuel liquid storing container used at the time of regular operation.

In the startup fuel supply circulation system, it is preferable to install a small-capacity circulation drive means for circulation and a venting means and it is preferable to simplify the equipment by supplying fuel for startup from the fuel liquid storing container used at the time of regular operation.

According to the present invention, the heat capacity of the fuel solution in the startup fuel supply circulation system is made smaller, so that even if the heat release value from the same cell is absorbed by heat transfer, the temperature rising speed of the fuel cell increases, and even at a low temperature, the cell temperature necessary for power generation can be obtained in a short period of time, thus the system can move to power generation. Therefore, the fuel consumption amount consumed at the start time can be reduced, thus the power generation efficiency and power generation capacity are improved.

### BRIEF DESCRIPTION OF THE DRAWINGS

FIG. 1 is a system block diagram showing the first embodiment of the fuel cell power generation system relating to the present invention,

FIG. 2 is a system block diagram showing the second embodiment of the fuel cell power generation system relating to the present invention, and

FIG. 3 is a system block diagram showing the third embodiment of the fuel cell power generation system relating to the present invention.

### DESCRIPTION OF THE PREFERRED EMBODIMENTS

Hereinafter, the detailed embodiments relating to the DMFC power generation system and the start up method thereof will be explained with reference to the accompanying drawings. However, the present invention is not limited to the embodiments indicated below.

### Embodiment 1

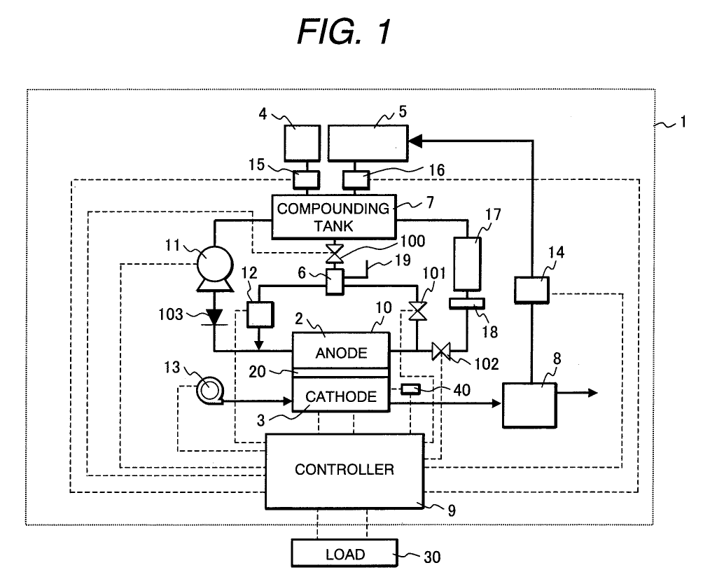

FIG. 1 is a block diagram showing an example of the constitution of the fuel cell power generation system of the present invention. A fuel cell system 1 of the present invention includes a power generation cell 10 formed by an electrolytic film 20 held between a pair of electrodes composed of an anode 2 and a cathode 3, a compounding tank 7 for compounding and storing a methanol water solution in low concentration used at the time of regular operation mainly in the power generation cell 10, and a startup methanol container 6 for storing a methanol water solution in an amount mainly used at the startup time.

Further, to compound a methanol water solution in low concentration by the compounding tank 7, the system 1 includes a diluted fuel tank 4 for storing a methanol water solution in high concentration for dilution and a water tank 5 for storing mainly water or a methanol water solution in very low concentration. The system 1 includes a diluted fuel supply means 15 for supplying a methanol water solution in high concentration from the diluted fuel tank 4 to the compounding tank 7 and a water supply means 16 for supplying water for methanol dilution from the water tank 5 to the compounding tank 7. Further, the system 1 includes an air supply means such as an air fan 13 for supplying air as an oxidizing agent to the power generation cell 10, a vapor-liquid separator 8 for separating water generated by the power generation cell 10 from the other substances, and a water collection pump 14 for sending water separated by the vapor-liquid separator 8 to the water tank 5.

Furthermore, the system 1 includes a fuel circulation pump 11 for supplying and circulating the methanol water solution of the compounding tank 7 to the power generation cell 10, a filter 18 for keeping the methanol water solution circulating by the fuel circulation pump 11 clean, a deaerator 17 for separating gas produced in the anode 2 of the power generation cell 10 from the methanol water solution circulating by the fuel circulation pump 11, a startup circulation pump 12 for supplying and circulating the methanol water solution of the startup methanol container 6 to the power generation cell 10, valves 101 and 102 for switching the flow paths of the methanol water solution of the compounding tank 7 and the methanol water solution of the startup methanol container 6, and a controller 9 for reading the measured value of the temperature measuring instrument and sending an instruction to the valves and pumps aforementioned.

The power generation cell 10 is composed of the electrolytic film 20 for transmitting protons and methanol and the anode 2 and cathode 3 having a catalyst in the power generation reaction and the electrolytic film 20 is held between the anode 2 and the cathode 3 so as to permit the two to compete with each other. The electrolytic film 20 for permeating protons and methanol is formed by a material having permeability, oxidation resistance, and heat resistance and the permeability of methanol is preferably low.

The anode 2 and cathode 3 are formed using a metallic material, a carbon material, or conductive non-woven and for example, when a carbon material is used, the porous surface of the carbon material may be carried with a catalyst such as platinum.

The cell reaction can be caused by supplying a methanol water solution in low concentration to the anode 2 and air to the cathode 3 from the air supply means. The methanol water solution in low concentration, in the anode 2, reacts as indicated by Formula 1 indicated below by the water and methanol in the methanol water solution in low concentration.

CH₃OH+H₂O→CO₂+6H⁺+6e⁻ Formula 1

Protons (H⁺) produced by this reaction transmit through the electrolytic film 20 and move to the cathode 3. Further, produced electrons (e⁻) pass though the external circuit from the anode 2 and move to the cathode 3. The moved protons and electrons, at the cathode 3, cause the reaction indicated by Formula 2 shown below with oxygen in the air supplied.

3/2O₂+6H⁺+6e⁻3H₂O Formula 2

Therefore, in the power generation cell 10 of the fuel cell system 1 of the present invention, by supplying a methanol water solution in low concentration and air, the cell reaction can be carried out.

Further, the power generation cell 10 generates heat due to the cell reaction, so that it has a temperature measuring sensor 40 for measuring the inner temperature of the power generation cell to detect the cell temperature and the temperature measuring sensor 40 is connected to the controller 9 for reading the inner temperature of the power generation cell and issuing an instruction to the valves.

The diluted fuel tank 4 is a storing container for storing methanol of the diluted fuel and is connected to the compounding tank 7 for storing a methanol water solution in low concentration via the diluted fuel supply means 15.

The diluted fuel supply means 15 is a pump or an adjustment valve, which is installed between the diluted fuel tank 4 and the compounding tank 7 and can send a predetermined amount of methanol of the diluted fuel tank 4 to the compounding tank 7.

The water tank 5 is a storing container for storing water collected by the vapor-liquid separator 8 and is connected to the compounding tank 7 for storing a methanol water solution in low concentration via the water supply means 16. The water supply means 16 is a pump or an adjustment valve, which is installed between the water tank 5 and the compounding tank 7 and sends a predetermined amount of water of the water tank 5 to the compounding tank 7. The diluted fuel supply means 15 and water supply means 16 are operated according to an instruction of the controller which will be explained below.

The compounding tank 7 is a storing container for storing a methanol water solution in low concentration at the time of regular operation and the startup methanol container 6 is a storing container for storing a methanol solution at the start time.

The compounding tank 7 is connected to the anode 2 of the power generation cell 10 via a check valve 103 which will be explained below and the fuel circulation pump 11. Further, to circulate a methanol water solution, the anode 2 is connected to the compounding tank 7 via the switching valve 102, the filter 18, and the deaerator 17.

The startup methanol container 6 is connected to the anode 2 of the power generation cell 10 via the startup circulation pump 12. Further, to circulate the methanol water solution, the anode 2 is connected to the startup methanol container 6 via the switching valve 101.

Further, in the startup methanol container 6, a venting means 19 is installed and separates gas included in a circulation liquid at the exit of the anode 2, mainly carbon dioxide from the methanol circulation liquid. Furthermore, the volume of the startup methanol container 6 and the inner volume of the pipe of the startup fuel supply circulation system are made smaller than the volume of the compounding tank 7 and the inner volume of the pipe of the circulation system thereof.

Furthermore, the startup methanol container 6 is connected to the compounding tank 7 and the methanol water solution of the compounding tank 7 is supplied to the startup methanol container 6 via a startup fuel supply means 100. The startup fuel supply means 100 is a pump or an on-off valve and in this embodiment, a structure is used that the methanol water solution in the compounding tank 7 flows downward from above using the gravity by the electromagnetic on-off valve with small power consumption.

The fuel cell power generation system 1 of this embodiment, since the compounding tank 7 and circulation system connected thereto and the startup methanol container 6 and startup circulation system connected thereto are installed respectively, can switch the circulation systems to be used at the start time and at the time of regular operation.

The fuel circulation pump 11 is installed between the compounding tank 7 and the power generation cell 10, supplies the methanol water solution in the compounding tank 7 to the anode 2, and returns the methanol water solution supplied to the anode 2 to the compounding tank 7. The fuel circulation pump 11 can operate in link motion with the valves connected to the controller 9. Further, the circulation flow rate of the methanol water solution can be controlled within the flow rate range of the specification for the fuel circulation pump.

The filter 18 is installed between the exit of the anode 2 and the compounding tank 7 and removes impurities in the methanol water solution.

The deaerator 17 is installed between the exit of the anode 2 and the compounding tank 7 and removes gas included in the methanol water solution, mainly carbon dioxide.

The startup circulation pump 12 is installed between the startup methanol container 6 and the anode 2, supplies the methanol water solution in the startup methanol container 6 to the anode 2, and returns the methanol water solution supplied to the anode 2 to the startup methanol container 6. The startup circulation pump 12 is connected to the controller 9 and operates in link motion with the valve 101. The startup circulation pump 12 is used only at the start time and the circulation flow rate is constant and does not need to be controlled particularly.

The vapor-liquid separator 8 operates in cooperation with the water collection pump 14 and is installed between the power generation cell 10 and the water tank 5. The separator 8 separates and stores water generated in the power generation cell 10 from exhaust gas together with air discharge by the air supply means indicated by the air fan 13. The exhaust gas with water separated is discharged outside the vapor-liquid separator 8.

The water collection pump 14 is installed between the vapor-liquid separator 8 and the water tank 5 and supplies water separated by the vapor-liquid separator 8 to the water tank 5.

The air supply means indicated by the air fan 13 is connected to the cathode 3 and supplies air to the cathode 13. Further, the air supply means is not limited to the air fan and any means, if it can supply air to the cathode 3, may be available. For example, an air pump can be used. Further, the air fan 13 is connected to the controller 9 and can be operated in link motion with the fuel circulation pump 11 and startup circulation pump 12. Further, the air supply rate to the cathode 3 can be controlled via the controller 9. By doing this, at the start time, the air flow rate is reduced from that at the time of regular operation, thus the heat removal rate from the power generation cell is reduced, and the temperature rise of the power generation cell can be quickened. Further, the power consumption can be reduced.

The valve 101 for switching the flow path is installed between the exit of the anode 2 and the startup methanol container 6 and can interrupt or enable the flow of a methanol water solution from the exit of the anode 2 toward the startup methanol container 6 via the controller 9.

The valve 102 for switching the flow path is installed between the exit of the anode 2 and the compounding tank 7 and can interrupt or enable the flow of a methanol water solution from the exit of the anode 2 toward the compounding tank 7 via the controller 9.

The check valve 103 is installed between the compounding tank 7 and the entrance of the anode 2 and prevents the startup circulation pump 12 from back flow of the methanol water solution to the compounding tank 7 during operation.

The controller 9 reads at least the numerical value of the temperature measuring sensor 40 and can control the air fan 13, fuel circulation pump 11, startup circulation pump 12, and flow path switching valves 101 and 102. For example, at the start time, the controller 9 turns off the fuel circulation pump 11, closes the valve 102, turns on the startup circulation pump 12, and opens the valve 101. By doing this, the methanol water solution in the startup methanol container 6 can be supplied to the anode 2. When the value of the temperature measuring sensor 40 rises to a predetermined temperature or higher, the controller 9 stops the startup circulation pump 12, closes the valve 101, opens the valve 102, turns on the fuel circulation pump 11, and by reading the temperature of the temperature measuring sensor 40 and controlling an appropriate methanol water solution amount in accordance with the temperature, supplies it from the compounding tank 7 to the anode 2.

Further, the startup fuel supply means 100 is opened at least before startup of the fuel cell power generation system 1 via the controller 9 and can supply the methanol water solution of the compounding tank 7 into the startup methanol container 6.

Further, the controller 9, when the methanol water solution in the compounding tank 7 is lower than the predetermined concentration, can supply methanol of the diluted fuel tank 4 to the compounding tank 7 by the diluted fuel supply means 15. Further, when the liquid quantity in the compounding tank 7 reduces below the predetermined liquid quantity, water of the water tank 5 can be supplied to the compounding tank 7 by the water supply means 16.

In the fuel cell power generation system 1 of the present invention, at the start time, the concentration of methanol water solutions in the compounding tank 7 and startup methanol container 6 is within the range from about 1 wt % to several tens of wt %, though it is not restricted particularly. However, so as to make the quantity of the methanol water solution in the startup methanol container 6 smaller than the quantity of the methanol water solution stored in the compounding tank 7, the volume of the startup methanol container 6 is set to be smaller than the volume of the compounding tank 7.

At the start time, the startup circulation pump 12 and air fan 13 are operated by an external battery (not drawn), and the methanol water solution in the startup methanol container 6 is sent to the anode 2, and air is sent to the cathode. By doing this, due to the cell reaction and oxidation reaction of a part of methanol, the methanol water solution generates heat and the temperature of the methanol water solution at the exit of the anode 2 becomes higher than that at the entrance of the anode 2 due to the heat transfer action in the anode 2. The methanol water solution at the exit of the anode 2 is returned to the startup methanol container 6 by the startup circulation pump 12 and is sent again to the anode 2.

Further, the power source for the startup circulation pump 12 and air fan 13 for which the power generation is started is switched from the external battery to the fuel cell power generation system 1 by the controller 9. Here, as the methanol water solution quantity possessed by the whole startup fuel supply circulation system including the startup methanol container 6 is reduced, the heat capacity of the methanol water solution which is fuel is reduced, so that the temperature rising speed of the circulating methanol water solution is higher than that of the circulation system for the regular operation having a larger heat capacity. The temperature rising speed of the methanol circulating liquid persistently depends most largely on the mass of the methanol water solution flowing through the startup fuel supply circulation system, which is greater than the influence of the supply speed. Further, the fuel cell temperature depends largely on the temperature of the methanol water solution and the temperature of the power generation cell rises almost in accordance with the temperature rise of the methanol circulation liquid. Therefore, by use of the startup fuel supply circulation system of the present invention, the temperature rising speed is increased, thus the temperature of the power generation cell can reach the cell temperature at which the rated power generation status can be obtained in a shorter period of time.

However, in the methanol water solution at the exit of the anode 2, carbon dioxide is produced by the electrochemical reaction and between the exit of the anode 2 and the startup methanol container 6, flow of two phases of vapor and liquid such as the methanol water solution and carbon dioxide is generated. During circulation of the methanol water solution through the startup fuel supply circulation system, if carbon dioxide stays in the system, the system is filled with gas and the circulation startup pump 12 cannot supply the methanol water solution to the anode 2. To prevent it, the startup methanol container 6 is equipped with the venting means 19. As a concrete example of the venting means 19, in this embodiment, the upper part of the startup methanol container 6 is equipped with a venting pipe and it is advised so as to discharge only gas including carbon dioxide into the air. Needless to say, if only gas can be separated from the startup methanol container 6, the venting means is not restricted particularly.

When the temperature of the power generation cell reaches the predetermined value, the controller 9 stops the startup circulation pump 12, closes the flow path switching valve 10, starts up the fuel circulation pump 11, opens the valve 102, and supplies the methanol water solution of the compounding tank 7 to the anode 2. Further, simultaneously, by the power control function provided in the controller 9, electricity begins to flow through a load 30. In this case, the methanol water solution flowing through the anode 2 is switched from the methanol water solution flowing through the startup fuel supply circulation system at a high temperature to the methanol water solution from the compounding tank at a low temperature and the temperature of the power generation cell 10 lowers. However, if the power generation output and representation are changed, the current increases, so that the heat release value increases, thus a sudden lowering of the cell temperature can be avoided.

To make the temperature change as smooth as possible, it is desirable to control the discharge flow rate of the fuel circulation pump 11 by the controller 9 and increase it slowly or stepwise.

### Embodiment 2

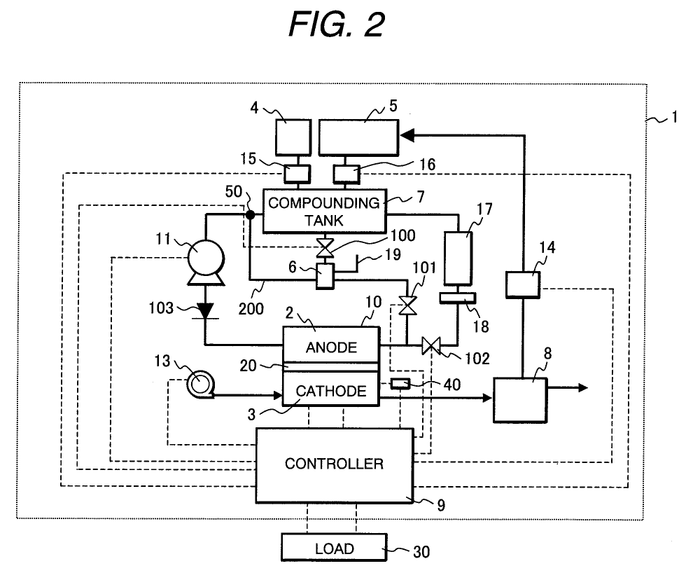

Another embodiment is shown in FIG. 2. In this embodiment, the methanol water solution coming out from the startup methanol container 6 is supplied to the anode 2 via the fuel circulation pump 11 arranged in the fuel supply circulation system for the regular operation. Therefore, a pipe 200 for connecting an optional position 50 between the fuel circulation pump 11 and the compounding tank to the startup methanol container 6 is installed.

The fuel circulation pump 11 in this embodiment is a pump having a wide range of the flow rate in use for covering from the low flow rate at the start time to the flow rate at the time of regular operation. The fuel circulation pump 11 can be operated at the start time and at the time of regular operation, thus a fuel supply means used only for startup is not required, resulting in simplification of the system and reduction in cost.

### Embodiment 3

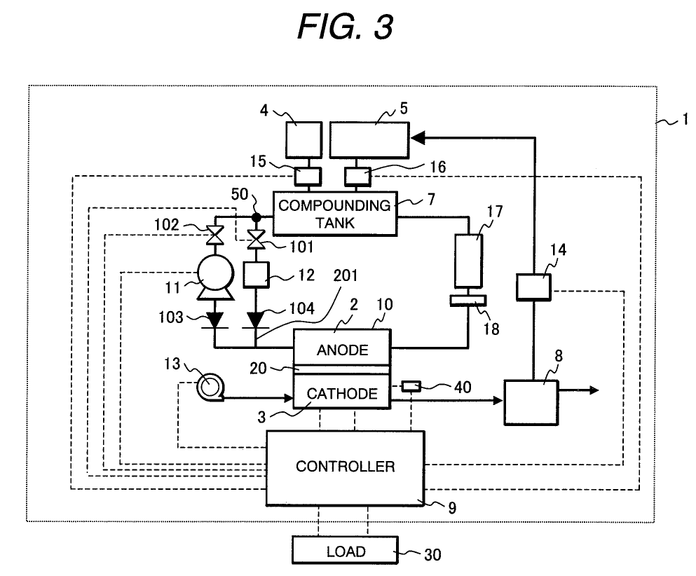

Still another embodiment is shown in FIG. 3. The system configuration of this embodiment is that the startup circulation system is bypassed in an ordinary fuel supply circulation system. Namely, a startup bypass system 201 connected from the exit of the compounding tank 7 to the entrance of the anode 2 is installed.

The startup bypass system 201 is equipped with the valve 101 toward the downstream side from the upstream side, the startup circulation pump 12, and a check valve 104. At the start time, the valve 102 installed in the fuel supply circulation system used at the time of regular operation is closed, and the valve 102 installed in the startup bypass system 201 is opened, and the startup circulation pump 12 is operated, thus fuel is supplied from the compounding tank 7 to the anode 2 and the methanol water solution is returned from the exit of the anode 2 to the compounding tank 7.

At the start time, to the compounding tank 7, methanol and water are supplied respectively from the diluted fuel tank 4 and water tank 5 and are adjusted to the predetermined liquid quantity and methanol concentration. The quantity of a methanol water solution compounded in the compounding tank 7 can be adjusted optionally by the diluted fuel supply means 15 and water supply means 16 via the controller 9.

At the start time, a small amount of methanol water solution is stored and via the startup bypass system 201, by the startup circulation pump 12, the methanol water solution of the compounding tank 7 is supplied to the anode 2. As the temperature of the startup circulation liquid rises, the temperature of the power generation cell 10 also rises, and when it reaches the predetermined temperature, the power generation output is increased, and electricity flows through the load. Simultaneously, from the diluted fuel tank 4 and water tank 5, methanol and water are respectively supplied continuously at a predetermined increase rate until a predetermined liquid quantity is obtained. Finally, the methanol water solution is supplied up to the quantity necessary at the time of regular operation.

In this embodiment, there is no need to install a new startup methanol container for startup, and the pipe for connecting the compounding tank and startup methanol container is not necessary, resulting in simplification of the system and reduction in cost.

What is claimed is:

1. A start up method for a fuel cell capable of directly generating power for supplying fuel to an anode of a power generation cell having a cathode and said anode across an electrolyte, supplying air to said cathode, and generating power by producing a direct reaction by an electrode, wherein fuel having a lower heat capacity than that at time of regular operation is supplied to said anode and said fuel at an exit of said anode is circulated again to an entrance of said anode.

2. A fuel cell power generation system capable of directly generating power comprising a power generation cell having a cathode and an anode across an electrolyte, a fuel supply circulation system for supplying fuel to said anode of said power generation cell and circulating again said fuel at an exit of said anode to an entrance of said anode, and an air supply system for supplying air to said cathode of said power generation cell, wherein said fuel supply circulation system has a fuel supply circulation system for regular operation and a startup fuel supply circulation system and a volume of a fuel solution in a pipe of said startup fuel supply circulation system is made smaller than a volume of a fuel liquid in a pipe of said fuel supply circulation system for regular operation.

3. The fuel cell power generation system according to claim 2, wherein fuel storing containers for storing a fuel liquid are installed respectively in said fuel supply circulation system for regular operation and said startup fuel supply circulation system and a volume of said fuel storing container in said startup fuel supply circulation system is smaller than a volume of said fuel storing container in said fuel supply circulation system for regular operation.

4. The fuel cell power generation system according to claim 3, wherein a venting section is installed in said fuel storing container of said startup fuel supply circulation system.

5. The fuel cell power generation system according to claim 3, wherein so as to supply fuel from said fuel storing container of said fuel supply circulation system for regular operation to said fuel storing container of said startup fuel supply circulation system, both fuel storing containers are connected.

6. The fuel cell power generation system according to claim 2, wherein a fuel storing container is installed in said fuel supply circulation system for regular operation, and halfway on a pipe connecting said fuel storing container and said entrance of said anode of said power generation cell, fuel circulation means is installed and halfway on a pipe connecting said exit of said anode and said fuel storing container, a filter and a deaerator are installed.

7. The fuel cell power generation system according to claim 2, wherein in said startup fuel supply circulation system, a fuel storing container smaller than a volume of a fuel storing container of said fuel supply circulation system for regular operation is installed, and halfway on a pipe connecting said fuel storing container and said entrance of said anode of said power generation cell, fuel circulation means is installed, and halfway on a pipe connecting said exit of said anode and said fuel storing container, an on-off valve is installed.

8. The fuel cell power generation system according to claim 3, wherein said pipe of said startup fuel supply circulation system is structured so as to be connected to said pipe of said fuel supply circulation system for regular operation in the vicinity of said entrance of said anode of said power generation cell, to branch from said pipe of said fuel supply circulation system for regular operation in the vicinity of said exit of said anode of said power generation cell, and to return to said fuel storing container of said startup fuel supply circulation system.

9. The fuel cell power generation system according to claim 3, wherein in addition to said fuel storing container of said fuel supply circulation system for regular operation, a pipe for supplying fuel of said fuel storing container to said entrance of said anode of said power generation cell, fuel circulation means, and a pipe for returning said fuel at said exit of said anode to said fuel storing container are installed, and said startup fuel supply circulation system branches from said fuel supply circulation system for regular operation in the vicinity of said exit of said anode and is connected to an entrance side of said fuel circulation means installed in said fuel supply circulation system for regular operation.

10. The fuel cell power generation system according to claim 2, wherein in said fuel supply circulation system for regular operation, a fuel storing container, a pipe for supplying fuel of said fuel storing container to said entrance of said anode of said power generation cell, a fuel circulation pump, and a pipe for returning said fuel at said exit of said anode to said fuel storing container are installed, and said startup fuel supply circulation system is bypassed and installed in parallel between an entrance and an exit of said fuel circulation pump installed in said fuel supply circulation system for regular operation, and in said bypass system, a small-capacity startup circulation pump having a smaller discharge flow rate compared with said fuel circulation pump of said fuel supply circulation system for regular operation is installed, and at the start time, into said fuel storing container installed in said fuel supply circulation system for regular operation, a smaller volume of fuel than that at the time of regular operation is injected and said system is started up by said startup circulation pump.

11. A fuel cell power generation system capable of directly generating power comprising a power generation cell having a cathode and an anode across an electrolyte, a fuel supply circulation system for supplying fuel to said anode of said power generation cell and circulating again said fuel at an exit of said anode to an entrance of said anode, and an air supply system for supplying air to said cathode of said power generation cell, wherein said fuel supply circulation system has a fuel supply circulation system for regular operation and a startup fuel supply circulation system and a heat capacity of a pipe of said startup fuel supply circulation system is made smaller than a heat capacity of a pipe of said fuel supply circulation system for regular operation.

12. The fuel cell power generation system according to claim 11, wherein fuel storing containers for storing a fuel liquid are installed respectively in said fuel supply circulation system for regular operation and said startup fuel supply circulation system and a volume of said fuel storing container in said startup fuel supply circulation system is smaller than a volume of said fuel storing container in said fuel supply circulation system for regular operation.

13. The fuel cell power generation system according to claim 12, wherein a venting section is installed in said fuel storing container of said startup fuel supply circulation system.

14. The fuel cell power generation system according to claim 12, wherein so as to supply fuel from said fuel storing container of said fuel supply circulation system for regular operation to said fuel storing container of said startup fuel supply circulation system, both fuel storing containers are connected.

15. The fuel cell power generation system according to claim 11, wherein a fuel storing container is installed in said fuel supply circulation system for regular operation, and halfway on a pipe connecting said fuel storing container and said entrance of said anode of said power generation cell, fuel circulation means is installed and halfway on a pipe connecting said exit of said anode and said fuel storing container, a filter and a deaerator are installed.

16. The fuel cell power generation system according to claim 11, wherein in said startup fuel supply circulation system, a fuel storing container smaller than a volume of a fuel storing container of said fuel supply circulation system for regular operation is installed, and halfway on a pipe connecting said fuel storing container and said entrance of said anode of said power generation cell, fuel circulation means is installed, and halfway on a pipe connecting said exit of said anode and said fuel storing container, an on-off valve is installed.

17. The fuel cell power generation system according to claim 12, wherein said pipe of said startup fuel supply circulation system is structured so as to be connected to said pipe of said fuel supply circulation system for regular operation in the vicinity of said entrance of said anode of said power generation cell, to branch from said pipe of said fuel supply circulation system for regular operation in the vicinity of said exit of said anode of said power generation cell, and to return to said fuel storing container of said startup fuel supply circulation system.

18. The fuel cell power generation system according to claim 12, wherein in addition to said fuel storing container of said fuel supply circulation system for regular operation, a pipe for supplying fuel of said fuel storing container to said entrance of said anode of said power generation cell, fuel circulation means, and a pipe for returning said fuel at said exit of said anode to said fuel storing container are installed, and said startup fuel supply circulation system branches from said fuel supply circulation system for regular operation in the vicinity of said exit of said anode and is connected to an entrance side of said fuel circulation means installed in said fuel supply circulation system for regular operation.

19. The fuel cell power generation system according to claim 11, wherein in said fuel supply circulation system for regular operation, a fuel storing container, a pipe for supplying fuel of said fuel storing container to said entrance of said anode of said power generation cell, a fuel circulation pump, and a pipe for returning said fuel at said exit of said anode to said fuel storing container are installed, and said startup fuel supply circulation system is bypassed and installed in parallel between an entrance and an exit of said fuel circulation pump installed in said fuel supply circulation system for regular operation, and in said bypass system, a small-capacity startup circulation pump having a smaller discharge flow rate compared with said fuel circulation pump of said fuel supply circulation system for regular operation is installed, and at the start time, into said fuel storing container installed in said fuel supply circulation system for regular operation, a smaller volume of fuel than that at the time of regular operation is injected and said system is started up by said startup circulation pump.

20. The fuel cell power generation system according to claim 2, wherein said power generation cell comprises a power generation cell of a solid polymer furl cell.
